(19) United States
(12) Patent Application Publication
(10) Pub. No.: US 2026/0307959 A1
(43) Pub. Date: Oct. 8, 2026

(54) JACK DEVICE

(71) Applicant: HURST ENGINEERED ADVANCED TECHNOLOGIES (HEAT) LLC, Reno, NV (US)

(72) Inventors: Stephen Lowell HURST, Reno, NV (US); Robert Ian HURST, Rescue, CA (US)

(73) Assignee: HURST ENGINEERED ADVANCED TECHNOLOGIES (HEAT) LLC, Reno, NV (US)

(21) Appl. No.: 19/640,249

(22) Filed: Apr. 6, 2026

Related U.S. Application Data
(60) Provisional application No. 63/783,487, filed on Apr. 4, 2025.

(51) Int. Cl. B66F 3/44; B65G 67/02

(52) U.S. Cl. CPC B66F 3/44; B65G 67/02

(57) ABSTRACT

A jack device for lifting a heavy object, including a first arm having a base at a distal end and a second arm attached substantially perpendicular to the first arm at a proximal end, the second arm including an extendable portion actuated by an eye ring, and the first arm including a power and electronics module capable of moving the proximal end relative to the distal end. A method of using the jack device to lift or lower a heavy object, by placing the jack device near an object to be lifted or lowered, extending the extendable portion of the second arm into or under the object to engage with the object, and actuating vertical movement of the first arm, thereby lifting or lowering the object. Methods of adding and removing an interchangeable equipment sled to/from a vehicle using the jack device.

### BACKGROUND OF THE INVENTION

### 1. Technical Field

The present invention relates to apparatus and equipment for improving the utility of pickup and flatbed light to medium duty trucks and devices for lifting heavy objects, especially equipment sleds.

### 2. Background Art

Light to medium duty trucks (less than 40,000 lbs. GVWR) are ubiquitous in the United States with significant numbers worldwide. Unit sales in the US are expected to exceed 3,000,000 in 2023 with an average cost in excess of $30,000 and an annual global market exceeding $200 billion. Such vehicles comprise a passenger compartment or cab seating 2 to 6 or more passengers and a utility platform, often in the form of a walled bed and tailgate or flatbed, either of which can be fitted with a utility skid bolted to the frame or bed. Utility skids come in various forms from water or fuel tanks, welding/generator equipment, etc., and, of particular interest herein, firefighting apparatus.

Fire departments in particular (both volunteer and fulltime) usually have multiple types of vehicles for different types of equipment. Some of the equipment, including pickup trucks, are dedicated for specialty purposes so any truck carrying that equipment is not used a majority of the time in most departments. This results in many vehicles that are just sitting around not in use, and taking up space in the firehouse. It would be advantageous to have interchangeable equipment units to reduce the number of trucks needed.

Also, the electrification of transportation is rapidly gaining momentum worldwide, including electric pickup trucks. It would be advantageous to have a utility skid comprising an auxiliary battery for extended range or mobile charging of other electric vehicles.

US Patent No. 3,770,060 to Forsyth, et al. discloses a firefighting unit that can be installed on a cargo truck 1. Equipment such as tanks 3, pump 4, and hose reels 5 are mounted on a frame that can be loaded onto the truck bed 11 and attached thereto. When not in use, the modular unit can be stored on a stand. The modular unit can also be placed at remote sites for use. Forsyth, et al., however, does not disclose a modular system that include other types of equipment on different skids or an easy method to lift and remove the unit.

US Patent No. 4,842,326 to DiVito discloses modular motor vehicles that have a plurality of interchangeable chassis modules that are easily connected and disconnected from the core vehicle. For example, a dumping module 122 can be added to the core vehicle. DiVito does not disclose a jack designed to easily lift the modules.

US Patent No. 10,850,659 to Stocks, et al. discloses a system 100 for an interchangeable truck bed unit 110 that detachably couples with a truck chassis. The bed unit 110 can be a dump truck bed, a heavy equipment bed, a bed for hauling minerals or mining equipment, a military gun turret bed, a military personnel transport bed, a military HUMVEE bed, a specialized bed (e.g., a glass carrier bed, a utility bed, a landscaping equipment bed), or a limousine bed. Stocks, et al. does not disclose a jack designed to easily lift the bed unit.

While interchangeable units of equipment for vehicles exist, they are not easy to mount and/or replace and require the use of a forklift or crane, as well as removal of bolts that fix the unit to the vehicle. There remains a need for easily mountable, demountable and remountable equipment units for pickup trucks and other vehicles as well as devices for lifting them.

### SUMMARY OF THE INVENTION

The present invention provides for a jack device for lifting a heavy object, including a first arm having a base at a distal end and a second arm attached substantially perpendicular to the first arm at a proximal end, the second arm including an extendable portion actuated by an eye ring, the first arm including a power and electronics module capable of moving the proximal end relative to the distal end.

The present invention also provides for a method of using the jack device to lift or lower a heavy object, by placing the jack device near an object to be lifted or lowered, extending the extendable portion of the second arm into or under the object to engage with the object, and actuating vertical movement of the first arm, thereby lifting or lowering the object.

The present invention provides for a method of adding an interchangeable equipment sled to a vehicle, by operating a jack device to lift the interchangeable equipment sled, placing the interchangeable equipment sled on the vehicle, and optionally locking the interchangeable equipment sled in place.

The present invention provides for a method of removing the interchangeable equipment sled from a vehicle by optionally unlocking the interchangeable equipment sled from the vehicle, operating the jack device to lift the interchangeable equipment sled from the vehicle, and moving the vehicle away.

### DESCRIPTION OF THE DRAWINGS

Other advantages of the present invention are readily appreciated as the same becomes better understood by reference to the following detailed description when considered in connection with the accompanying drawings wherein:

FIG. 1 is a side view of the jack device;

FIG. 2 is a view of the jack device inserted in a jack receiving slot of an interchangeable equipment sled;

FIG. 3 is a view of the jack device inserted in a jack receiving slot of an interchangeable equipment sled;

FIG. 4 is rear left quarter panel perspective view of a vehicle with an interchangeable equipment sled;

FIG. 5 is a rear right quarter panel perspective view of a vehicle with an interchangeable equipment sled;

FIG. 6 is a rear left side perspective view of a frame of the interchangeable equipment sled with equipment;

FIG. 7 is a back view of a frame of the interchangeable equipment sled with equipment;

FIG. 8 is front view of a control panel;

FIG. 9 is a side view of piping;

FIG. 10 is a front view of a control panel;

FIG. 11 is a right rear side perspective view of a control panel;

FIG. 12 is a rear view of a vehicle with an interchangeable equipment sled;

FIG. 13 is a view of an illuminated control panel;

FIG. 14 is a side perspective view of a water tank with baffles and top mounted equipment storage racks;

FIG. 15A is a top perspective view of an attachment mechanism in a truck bed, FIG. 15B is a side view of a gooseneck puck, and FIG. 15C is a side perspective view of the interchangeable equipment sled attached within a truck bed;

FIG. 16 is a front view of jack extensions; and

FIG. 17 is a perspective view of jack extensions used in the jack device attached to an interchangeable equipment sled.

### DETAILED DESCRIPTION OF THE INVENTION

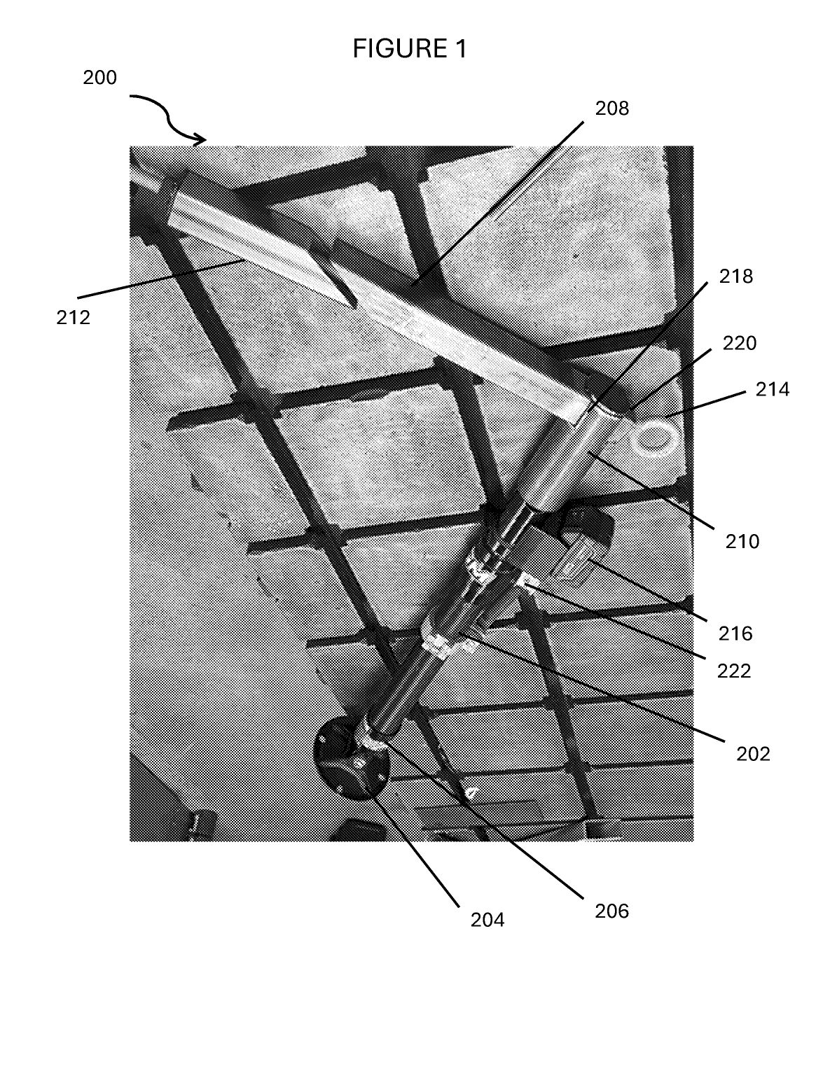

The present invention is generally directed to a jack device 200 and methods of lifting heavy objects with the jack device 200, such as an interchangeable equipment sled 10 shown and described in U.S. Patent Application No. 19/107,413, incorporated herein by reference. The jack device 200 is shown generally in FIG. 1, and includes a first arm 202 having a base 204 at a distal end 206 and a second arm 208 attached perpendicular to the first arm 202 at a proximal end 210, the second arm 208 including an extendable portion 212 actuated by an eye ring 214 to engage with an object to be lifted, the first arm 202 including a power and electronics module 216 capable of moving the proximal end 210 relative to the distal end 206. The jack device 200 is advantageous in that it is lightweight, removeable, and can be used for multiple purposes.

The first arm 202 can be a standard jack such as one by All German Motorsports (AGM) and can be made of any suitable metal or alloy (such as steel) in a generally cylindrical shape. The first arm 202 can be any suitable height to engage with and lift an object, and can come in various heights for different purposes. Standard AGM jacks, for example, adjust from approximately 35 inches fully retracted to 48 inches fully extended, for a total travel distance of up to about 13 inches. The proximal end 210 can be integrated with the first arm 202 and be made of the same materials or it can be operably attached to an existing jack or jack extension 224, such as a DOM (drawn over mandrel) steel tubing (for example, 3” diameter tubing). The first arm 202 is capable of moving and expanding in a vertical direction, i.e., the proximal end 210 can be moved away from the distal end 206 to raise the second arm 208 or the proximal end 210 can be moved towards the distal end 206 to lower the second arm 208.

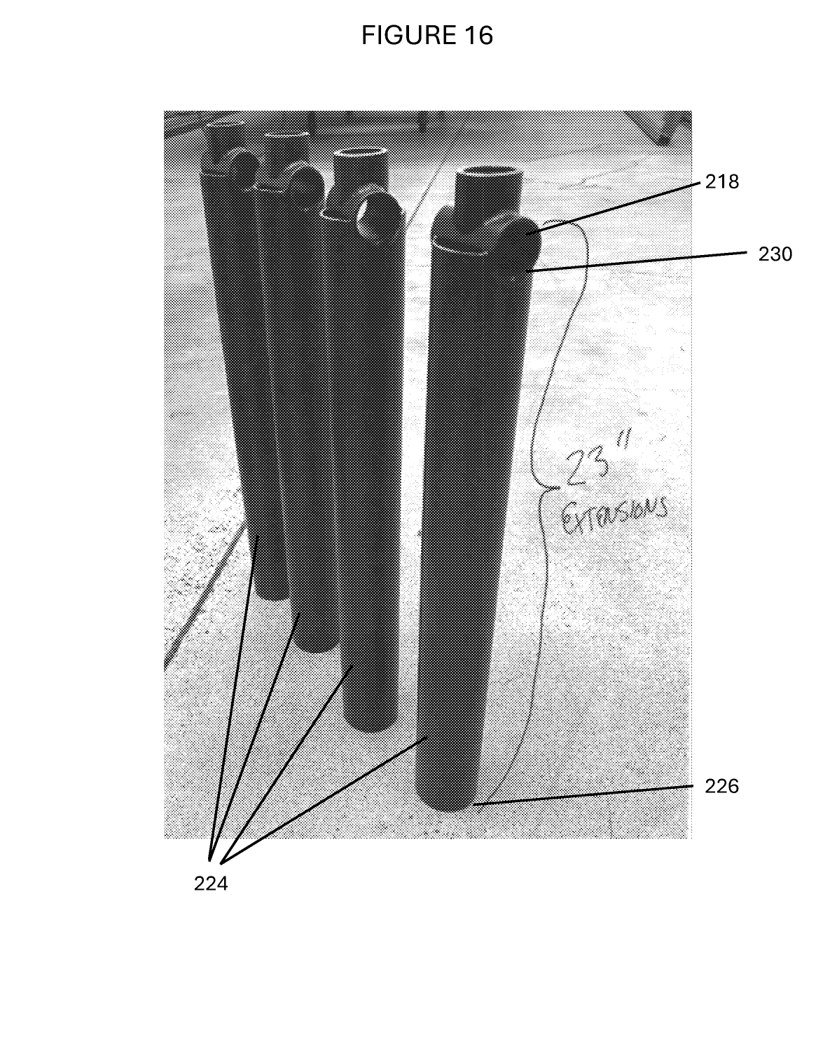

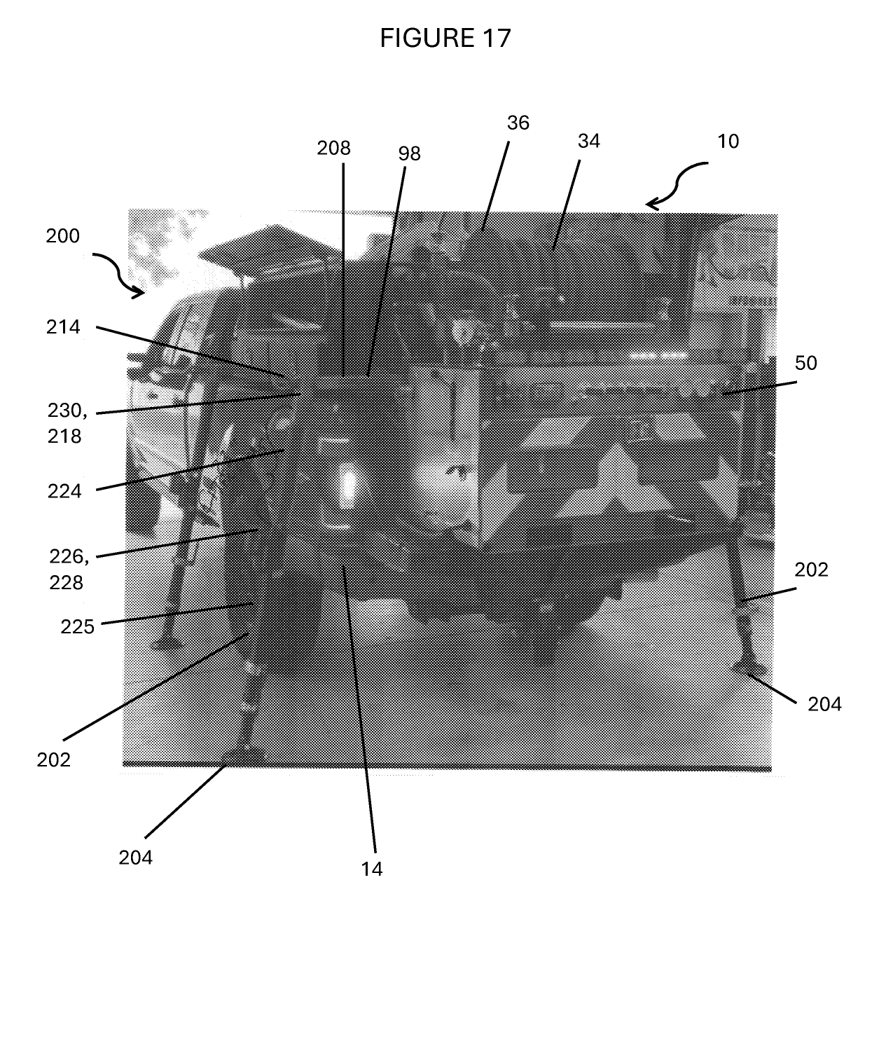

Jack extensions 224 (shown in FIGS. 16-17) can fit on top of an existing jack 225 in order to provide additional height to reach the object being lifted. Jack extensions 224 can be any desired length, such as 23” shown in the FIGURES. Jack extensions 224 include a distal end 226 that fit on a proximal end 228 of an existing jack 225, and a proximal end 230 that is attached to the second arm 208 as described below through slot 218.

The base 204 (or foot pad) can be made of metal, plastic, or other suitable materials, can include gripping materials, and is generally in a circular shape. The base 204 provides support to the first arm 202 and ensures that the jack device 200 does not slip.

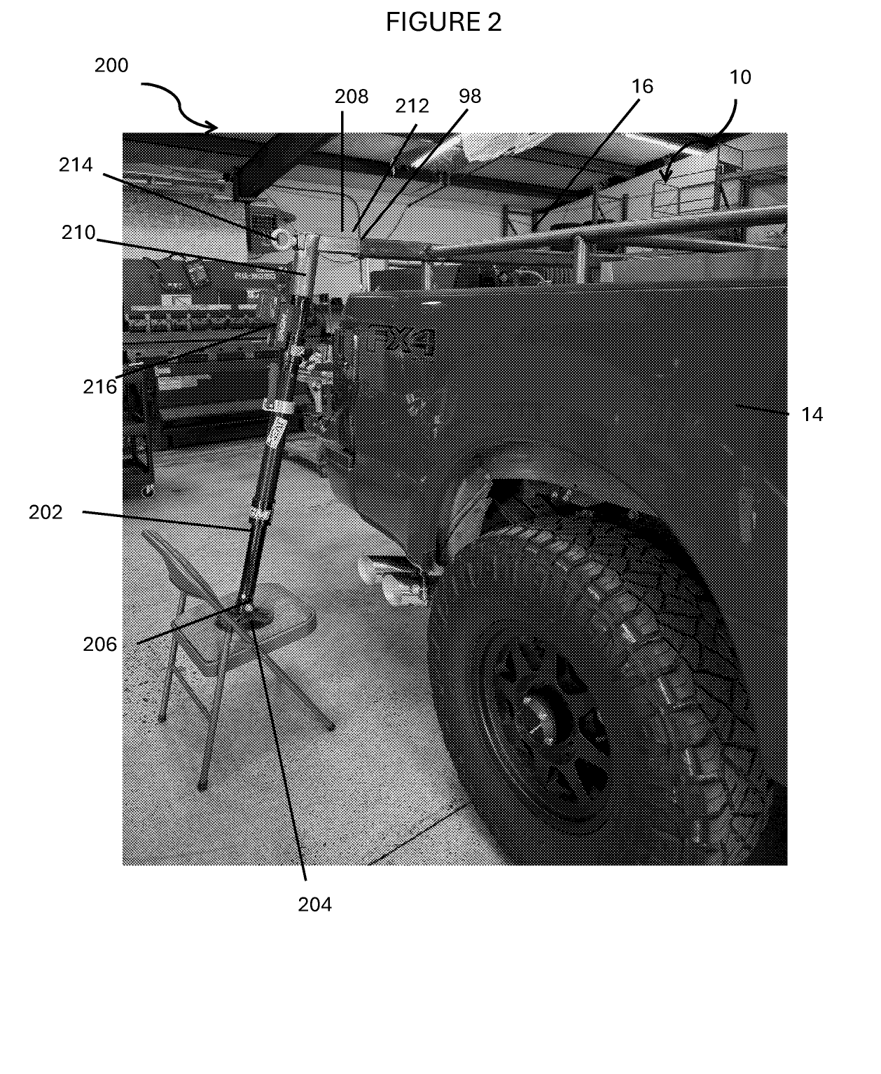

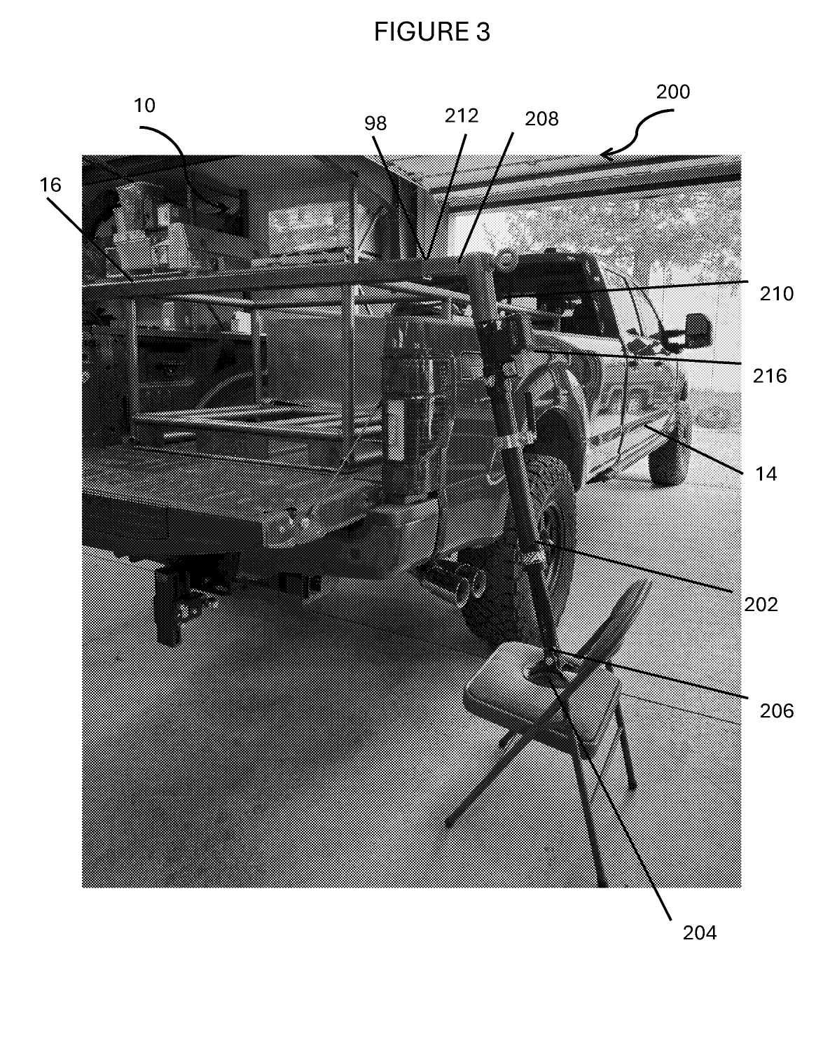

The second arm 208 is operably attached substantially perpendicular (but can be slightly angled) to the proximal end 210 of the first arm 202 for engaging with an object to be lifted. The second arm 208 can fit through a slot 218 in the proximal end 210 (the slot 218 can either be part of the first arm 202 or the jack extension 224). The second arm 208 can be made from 2” square metal tubing or any other appropriate tubing. The eye ring 214 can run though a center of the second arm 208 from a first end 220 (which can extend slightly beyond the first arm 202) through at least a portion of the extendable portion 212. The eye ring 214 can be easily rotated to extend the extendable portion 212 into or under a portion of an object, such as jack receiving slot 98 of the interchangeable equipment sled 10 (shown in FIGS. 2 and 3) in order to engage the jack device 200 with the object. Rotation of the eye ring 214 in a first direction can extend the extendable portion 212, and rotation of the eye ring 214 in a second direction can retract the extendable portion 212. When the extendable portion 212 is inserted into the jack receiving slot 98, this creates a friction-based anchor to secure the interchangeable equipment sled 10.

The power and electronics module 216 can include a battery (rechargeable or disposable, such as a MILWAUKEE® battery) to actuate the jack device 200. The power and electronics module 216 can include a switch 222 for actuation of the jack device 200. The switch 222 can be a physical switch operated manually or wirelessly such as with a BLUETOOTH® switch operated remotely from a controlling application on a smartphone/tablet/computer, and any hardware necessary for BLUETOOTH® communication can be included within the power and electronics module 216. When multiple jack devices 200 are employed, the operation of each jack device 200 individually or all together is greatly facilitated by wireless or BLUETOOTH® controls.

The present invention generally provides for a method of using the jack device 200 to lift or lower heavy objects, by placing at least one jack device 200 near an object to be lifted or lowered, extending the extendable portion 212 of the second arm 208 into or under the object to engage with the object, and actuating vertical movement of the first arm 202, thereby lifting or lowering the object. More specifically, the extending step can include rotating the eye ring 214 in a first direction to extend the extendable portion 212 into or under the object. Actuating vertical movement of the first arm 202 can include operating the switch 222 either manually or remotely by BLUETOOTH®. The jack device 200 can also be removed when the object is placed on a desired area (such as a vehicle 14 or platform) by rotating the eye ring 214 in the second direction to retract the extendable portion 212 of the second arm 208. Once the extendable portion 212 has cleared the object, the jack device 200 can be removed.

Additional uses of the jack device 200 can include hanging hoses, ladders, or hard lines. By rotating second arm 208 180 degrees in the jack receiving slot 98, proximal end 210 forms a “hook” which can hold rolls of hose, rope or the like and when more than one second arm 208 is rotated on a side of interchangeable equipment sled 10 these “hooks” can retain longer equipment such as ladders and hard line drafting hoses.

Most preferably, the jack device 200 is used with the interchangeable equipment sled 10 in the following methods. The present invention provides for a method of adding the interchangeable equipment sled 10 to a vehicle 14, by operating the jack device 200 to lift the interchangeable equipment sled 10, placing the interchangeable equipment sled 10 on the vehicle, and optionally locking the interchangeable equipment sled 10 in place. The interchangeable equipment sled 10 can be initially on the ground, on a storage platform or other area. The jack devices 200 can be placed near each jack receiving slot 98 and the extendable portion 212 can be extended into the jack receiving slot 98 by rotating the eye ring 214 in a first direction. Vertical movement of the jack devices 200 can be actuated as above to raise the interchangeable equipment sled 10 to a height wherein a vehicle 14 can fit under it (if necessary), and when the vehicle 14 is in place, vertical movement of the jack devices 200 can be actuated to lower the interchangeable equipment sled 10 onto the vehicle 14. The jack devices 200 can be removed by rotating the eye ring 214 in the second direction to retract the extendable portion 212 of the second arm 208. Once the extendable portion 212 has cleared the jack receiving slots 98, the jack devices 200 can be removed and the vehicle 14 can drive away.

The present invention provides for a method of removing the interchangeable equipment sled 10 from a vehicle by optionally unlocking the interchangeable equipment sled 10 from the vehicle, operating the jack device 200 to lift the interchangeable equipment sled 10 from the vehicle 14, and moving the vehicle 14 away. The jack devices 200 can be placed near each jack receiving slot 98 and the extendable portion 212 can be extended into the jack receiving slot 98 by rotating the eye ring 214 in a first direction. Vertical movement of the jack devices 200 can be actuated as above to raise the interchangeable equipment sled 10 to a height wherein the interchangeable equipment sled 10 clears the vehicle 14 and the vehicle 14 can drive away. The interchangeable equipment sled 10 can further be moved to a platform and/or other storage area.

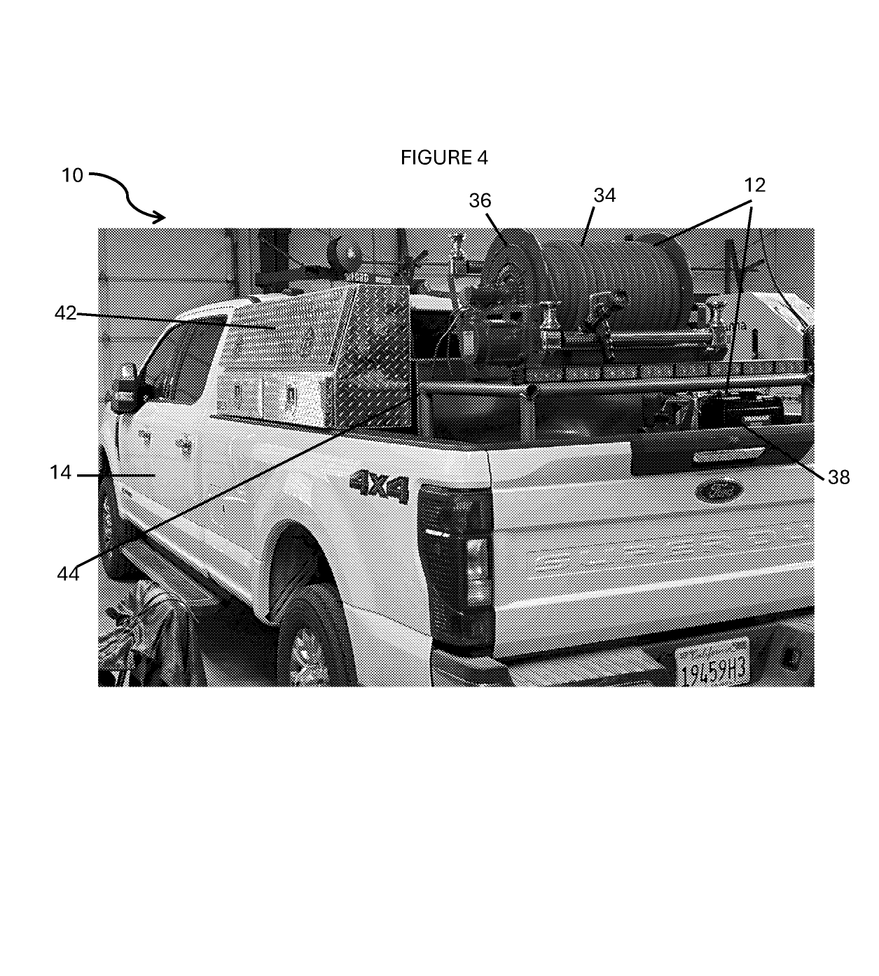

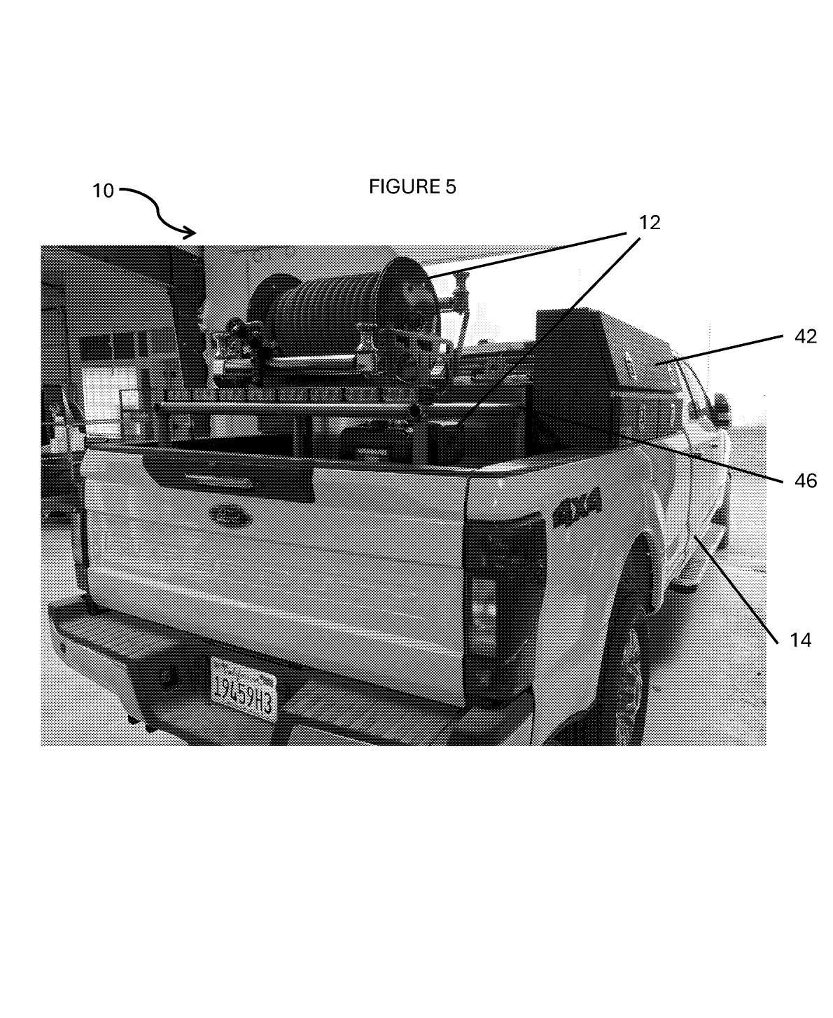

The following are further details regarding the interchangeable equipment sled 10. The interchangeable equipment sled 10 includes a frame 16 holding equipment 12 and is easily and rapidly mountable on or demountable from a vehicle 14, shown generally in FIGS. 4 and 5. The interchangeable equipment sled 10 allows for an individual to have one vehicle 14 that can be used for multiple purposes. While the interchangeable equipment sled 10 is shown in the FIGURES for the purposes of firefighting, it should be understood that the interchangeable equipment sled 10 can be designed for other uses further described below.

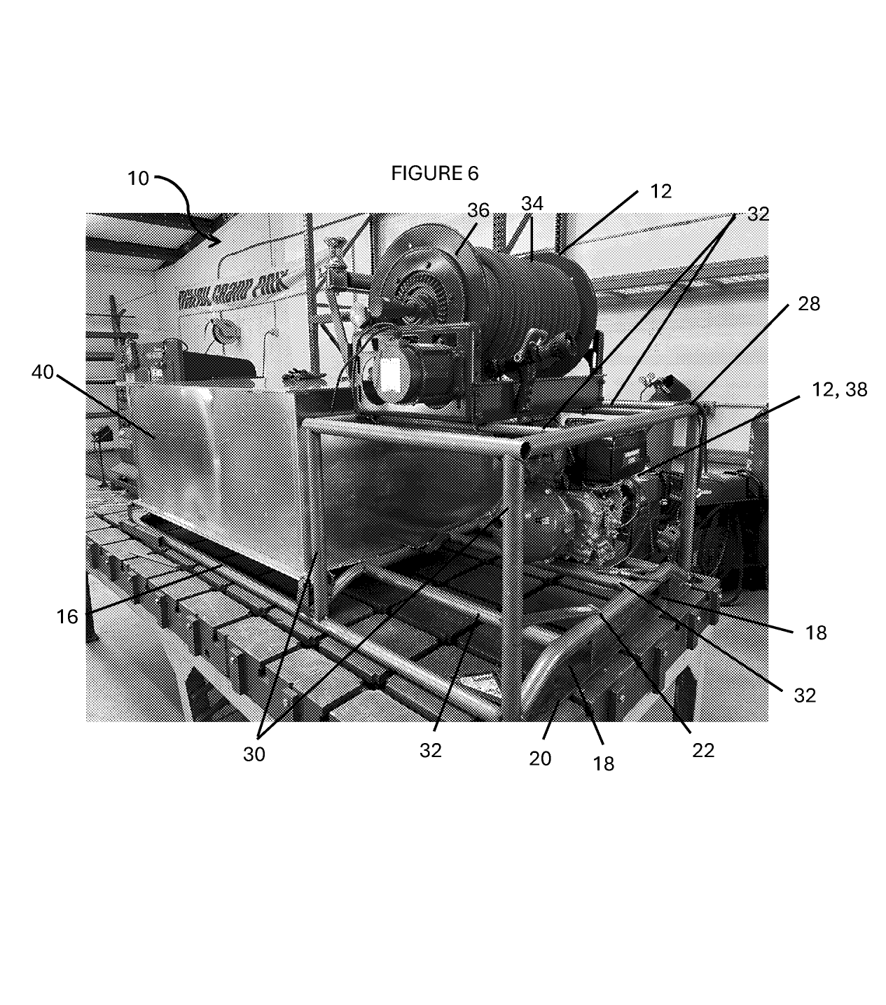

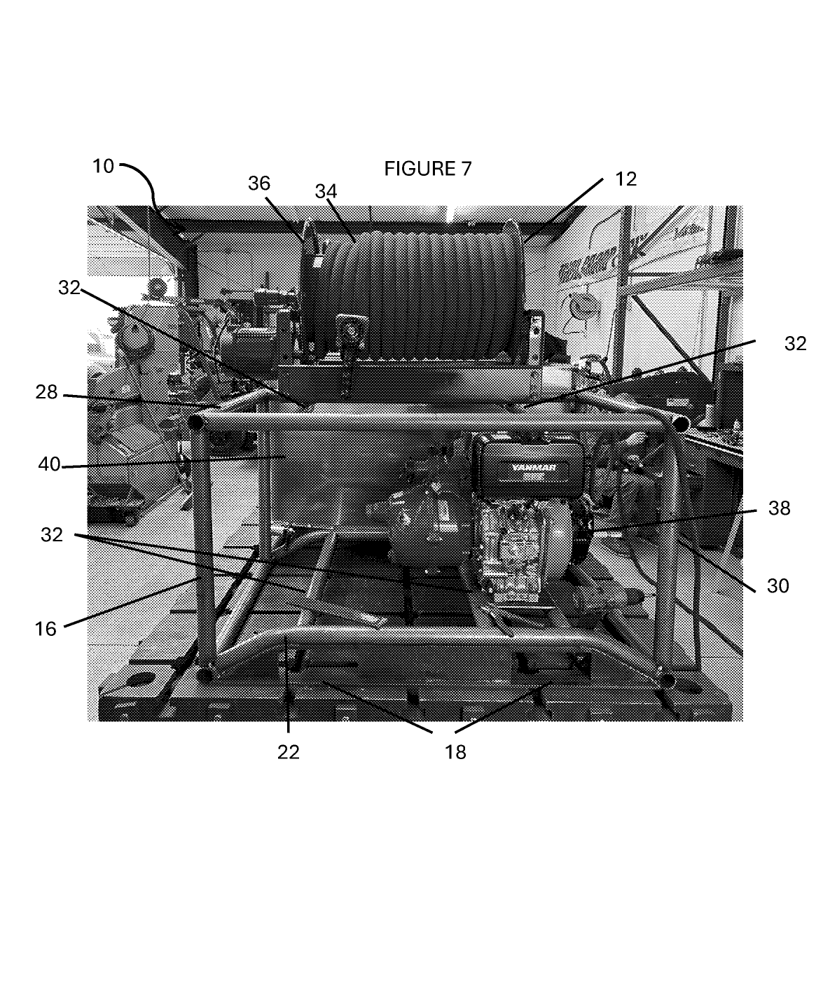

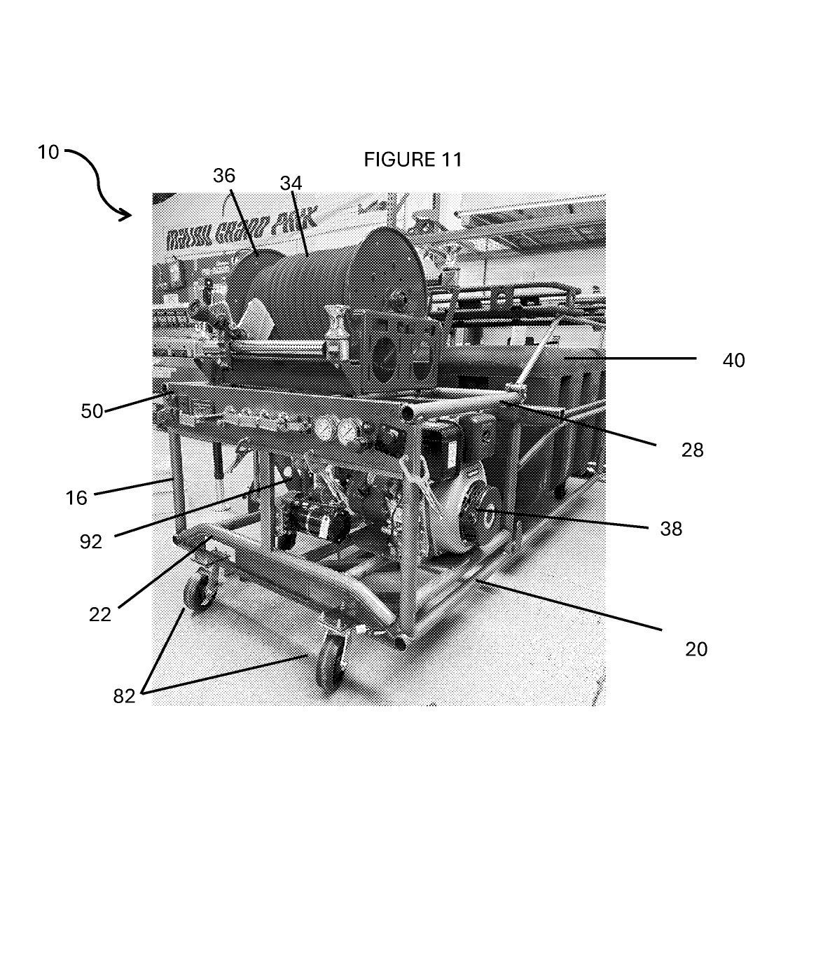

The interchangeable equipment sled 10 includes a frame 16 made of a lightweight and strong material, generally shown in shown in FIGS. 6-7, such as 120 wall 1.75 inch tube steel. The frame 16 can be solid or preferably hollow to reduce weight of the interchangeable equipment sled. The interchangeable equipment sled 10 can be made within the weight requirements of various trucks and cars, as well as still allow for space within the vehicle 14, such as within a truck bed 15 or trunk space if needed. The frame 16 includes a base portion 20 and a raised portion 22 operatively attached to the base portion 20. The frame 16 is strong enough to be lifted with the jack device 200. The raised portion 22 protects any equipment 12 on the frame 16 from contact with the jack device 200. The raised portion 22 can include a plurality of crossbars 32 to support equipment 12. The raised portion 22 can run an entire length of the frame 16 or a part of the frame 16. The frame 16 can also include a top portion 28 for receiving equipment 12 that is operatively attached through a plurality of vertical portions 30 to the base portion 20. The top portion 22 can run an entire length of the frame 16 or a part of the frame 16. The top portion 22 can also include a plurality of crossbars 32 to support equipment 12. The frame 16 can include additional support structures 92 (such as crossbars) where needed such as shown in FIG. 11. The frame 16 can be sized to fill a vehicle bed 15 for stability or be sized less than a bed so that there is room for loading additional things on the vehicle 14. The frame 16 can generally be rectangular or square in shape.

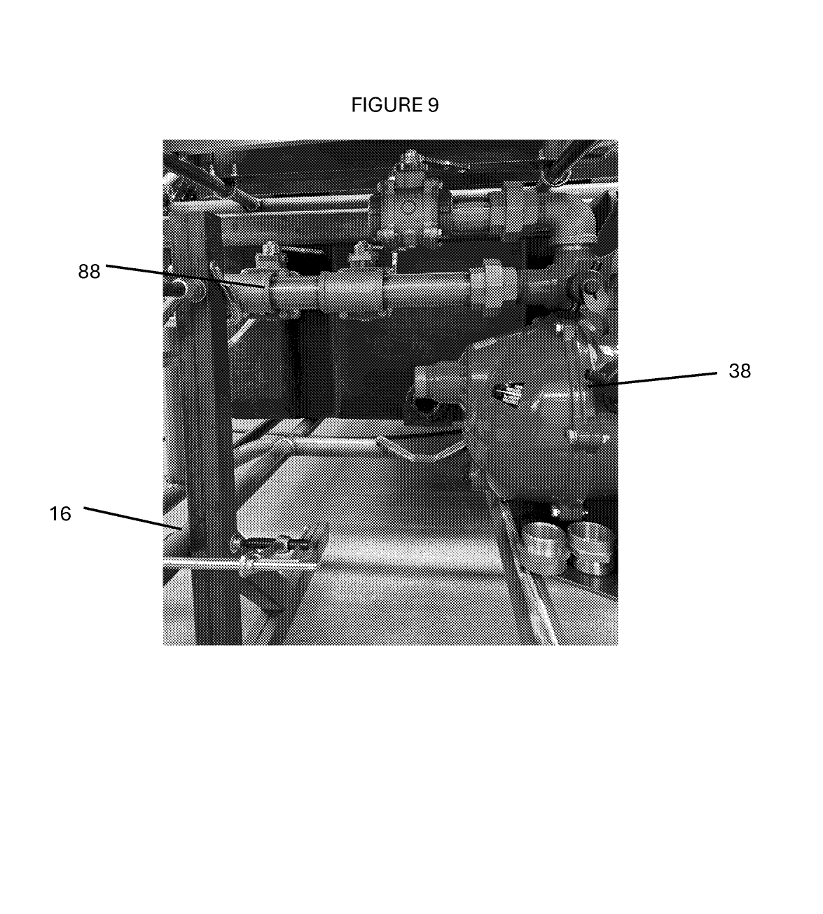

The equipment 12 can be fire equipment (hoses, water tanks, foaming devices which can provide up to 2400 gallons of fire suppression capability or more), batteries (to provide battery power at a remote site or to provide additional battery power/extended range to a vehicle 12), fuel tanks (to provide extended range of fuel to a vehicle 14), pesticide tanks for applying pesticides, dumpster equipment, welding equipment, salt or sand equipment for snow plows or sanding uses, or any other type of equipment or combinations of equipment. Custom combinations of equipment types can be included, and equipment 12 can be located in any desired part of the frame 16. For example, in the FIGURES, a hose 34 and hose reel 36 are provided on the top portion 28 of the frame 16 and a pump 38 is provided on the raised portion 22 that is operably connected to a water tank 40 and the hose 34. The pump 38 can be in fluid connection with the hose 34 and/or water tank 40 with easy to assemble and disassemble conduits 88 shown in FIG. 9.

The hose 34 can be a 1" Forestry Discharge Booster Fire Hose Reel-Lite 100' NPSH (NFPA Rated) RED and Nozzle that includes single jacket construction with abrasion resistant cover, rigid helical reinforcement with ethylene propylene diene monomer (EPDM) rubber lining, field replaceable fittings, is lightweight and kink resistant, and rated 400/800/1200 Service/Proof/Burst. A set of hoses 34 can be included such as 1 x 2.52 50’ forestry hose, 3 x 1.52 100’ forestry hose, and 3 x 12 100’ forestry hose. A foam cartridge nozzle system can be included for full foam capability without a foam tank.

The hose reel 36 can be a HANNEY® F32-19-21 steel hose reel. This includes a gear-driven crank rewind, electric powered chain and sprocket drive, pinion brake, standard inlet of 1" 90° ball bearing swivel joint with 1" female NPT threads, standard outlet of 1" male NST threads (1.375" x 8 threads per inch), standard inlet, outlet riser, and hub assembly made of steel, front and rear rollers, standard pressures to 1000 psi (69 bar), and standard fluid temperatures from -40° F to +250 °F (-40° C to +121° C).

A side mounted 1.5” MNHT discharge and top mounted 2.52 FNHT 90° elbow inlet for drafting or hydrant connection can be included.

A plurality of top mounted hose or equipment racks and side mounted, single box over two drawer utility compartments can be included.

The pump 38 can be a two stage fire pump with 10 hp YANMAR® diesel electric start engine. Alternatively, a Honda gasoline engine can be used. The diesel engine has low oil protection and a spark arrestor/exhaust diverter. The performance can be 120 gpm (454 L/M) at @ 36 psi (2.5 bar), 95 gpm (378 L/M) at 83 psi (5.7 bar), 60 gpm (227 L/M) at 118 psi (8.1 bar), or 20 gpm (76 L/M) at 144 psi (9.9 bar). It features marine-grade aluminum casing, 3-way discharge port with one 11⁄22 NPTM or two 1" NPTM, 11⁄2” NPTM suction, zinc-plated casing bolts, mechanical shaft seal, nitrile rubber seal and casing "o" rings, and self-priming up to 19’. A HALE® fluidless priming pump assures drafting performance.

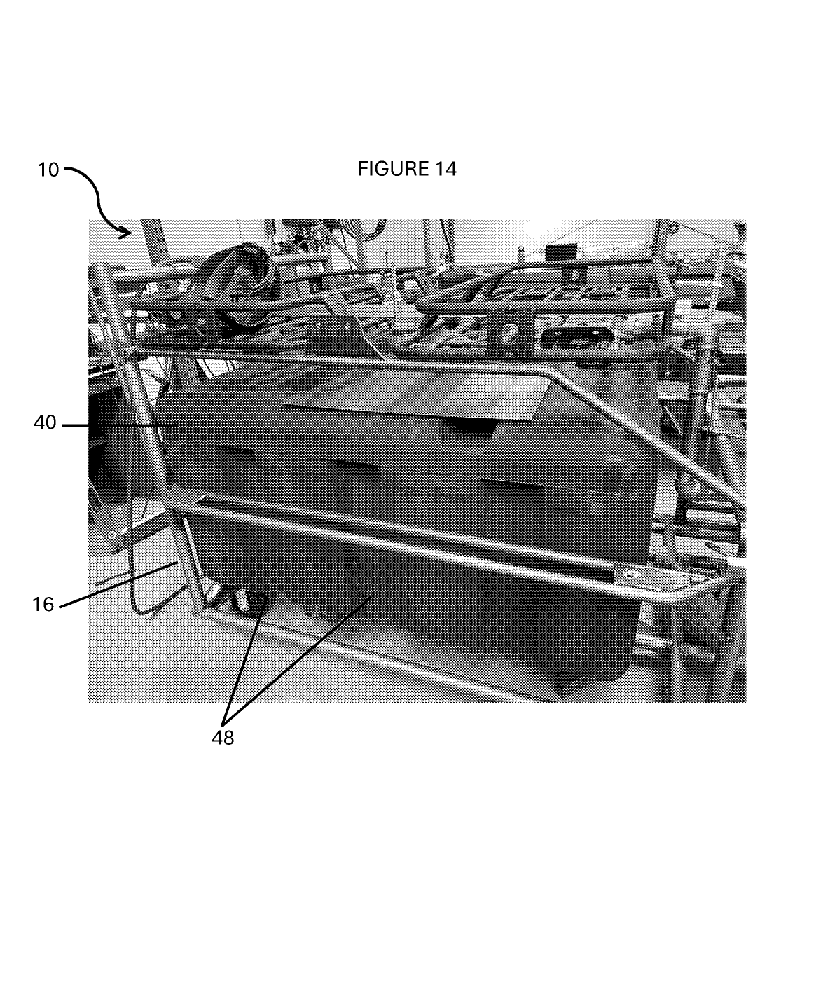

The water tank 40 can also be provided on the raised portion 22. The water tank 40 can be made of molded plastic or metal and optionally include a plurality of baffles 48 (shown in FIG. 14) to prevent unwanted movement of water in the water tank 40. The baffles 48 can be located in alternating locations on each side of the water tank 40. The water tank 40 can be any suitable size, such as, but not limited to, 300 gallon, 200 gallon, or 150 gallon. At least one utility box 42 can be included on the frame 16 in any suitable location such as on a first side 44 or second side 46. The equipment 12 can be operatively attached and mounted on the interchangeable equipment sled 10 by any appropriate mechanism and can be easy to remove.

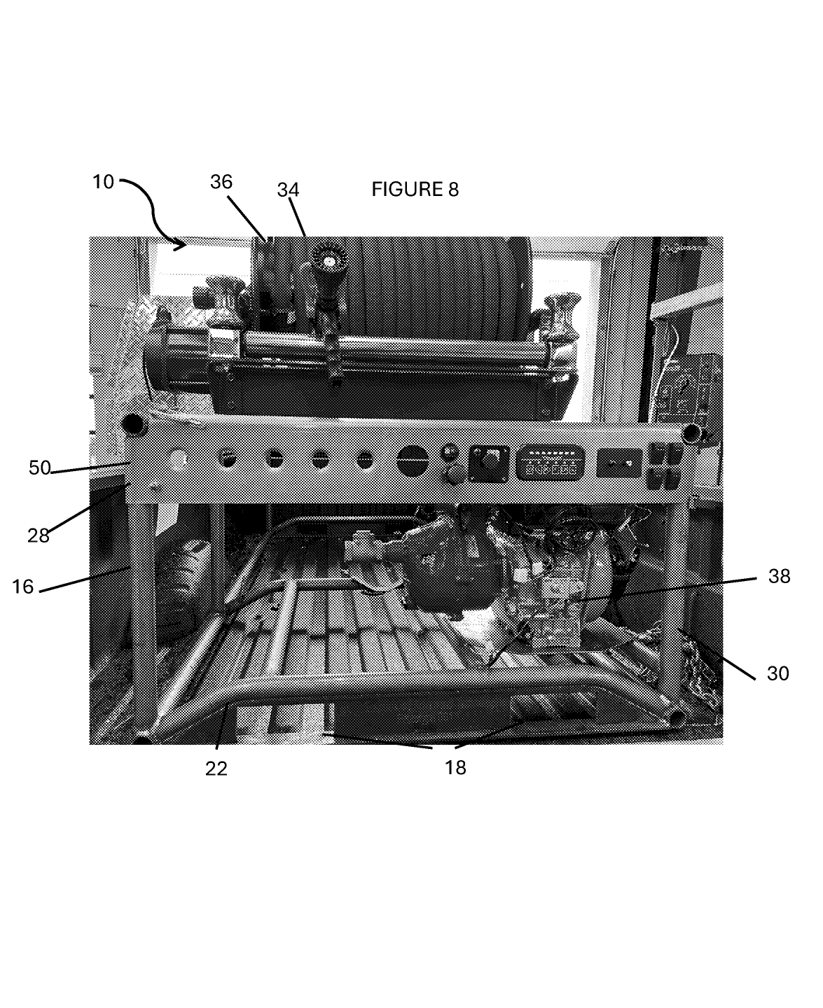

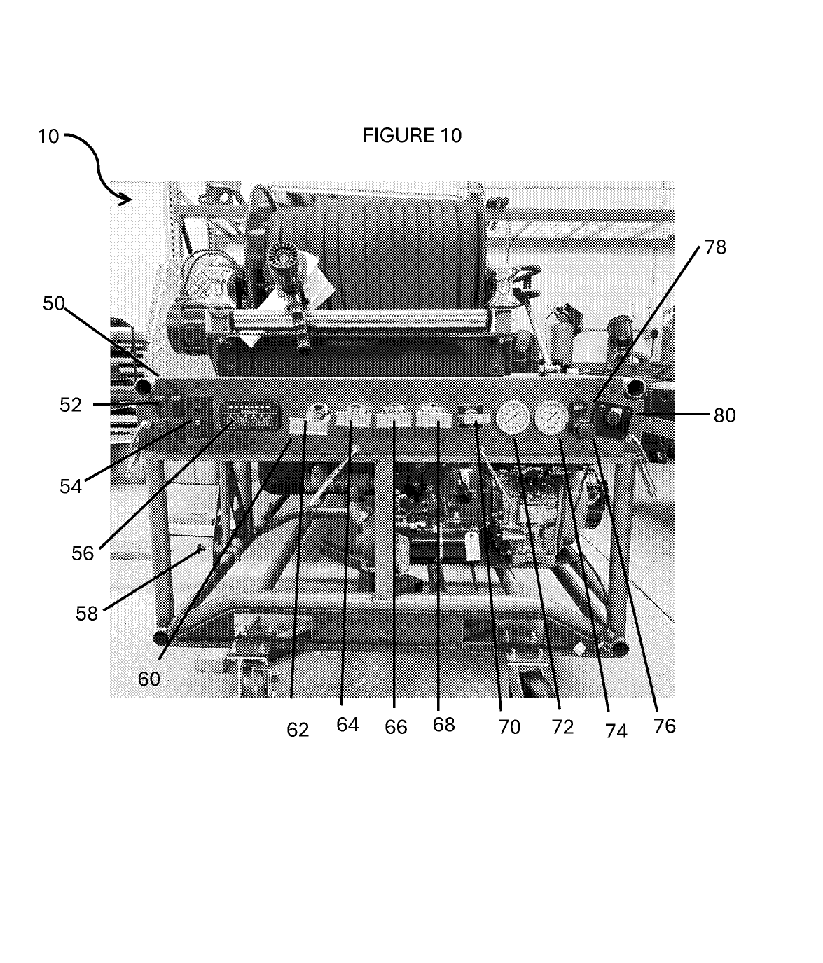

A control panel 50 (shown in FIGS. 8 and 10-12) can be operatively attached to the frame 16 in any suitable location but preferably along the top portion 28. The control panel 50 can be made of the same materials as the frame 16 or any other suitable material. Arranged on the control panel 50 can be controls for the equipment 12 as well as other functions as desired. For example, for firefighting uses, the control panel 50 can include at least one light switch 52, a remote spot light 54 (that can be 320 degrees rear facing), a traffic director control 56 (such as by WHELEN®), a hose reel switch 60, a hose reel valve 62, a discharge valve 64 (such as 1.5 inch), a tank fill/recirculate valve 66, a tank to pump valve 68, a primer switch/valve 70 an inlet pressure gauge 72 (such as 2.5” HALE® pressure gauge), a discharge pressure gauge 74 (such as 2.5” HALE® pressure gauge), a pump throttle 76, a tank level gauge 78, and a pump electric start 80. A drain valve 58 is also included operably attached to the water tank 40. Any valve handles can be panel mounted push/pull valve handles with 1.5” AKRON BRASS® stainless steel ball valves. A side swing handle 2.5” AKRON BRASS® stainless steel ball inlet valve can be used.

Electronic equipment can be included as follows. A self-contained 12 VDC marine grade electrical system can include a 12 VDC deep cycle batter, AC/DC shoreline charger, DC/DC charger connected through a 7 blade trailer pig tail, solar trickle charger for extended off bed use, and a pump alternator that charges the battery while pumping. LED lighting can be used in the control panel 50, pump house, and any compartments. A GPS tracking device can be included on any interchangeable equipment sled 10 to allow a user to locate and retrieve field deployed equipment remotely.

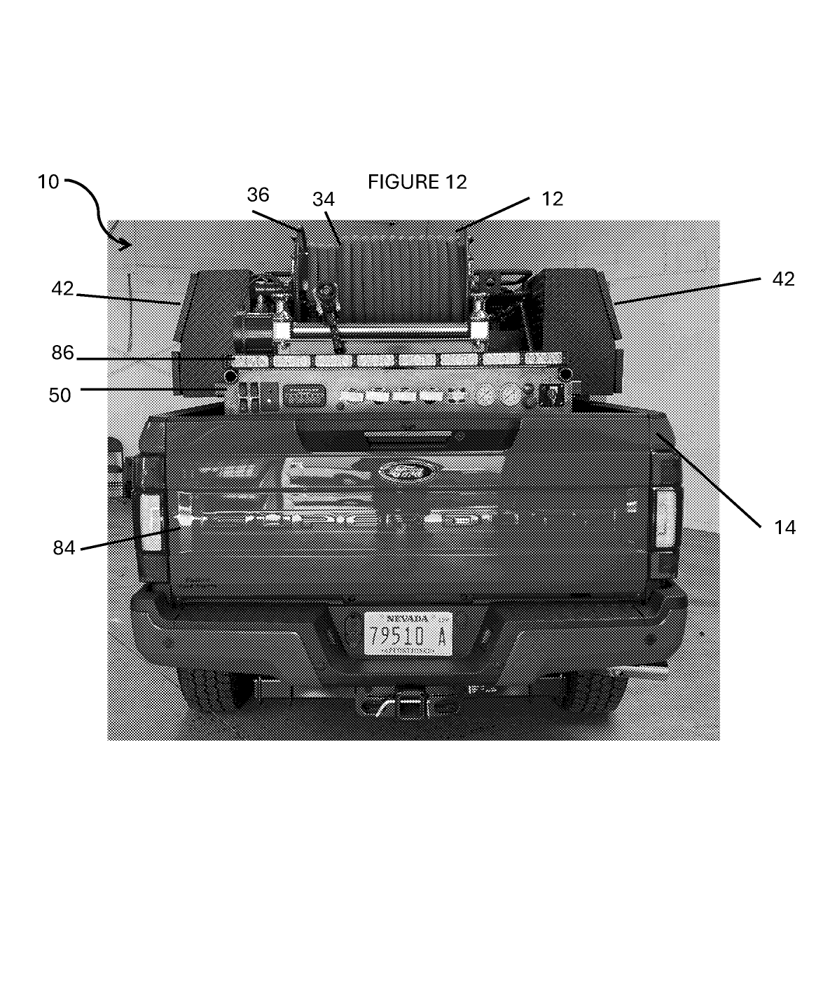

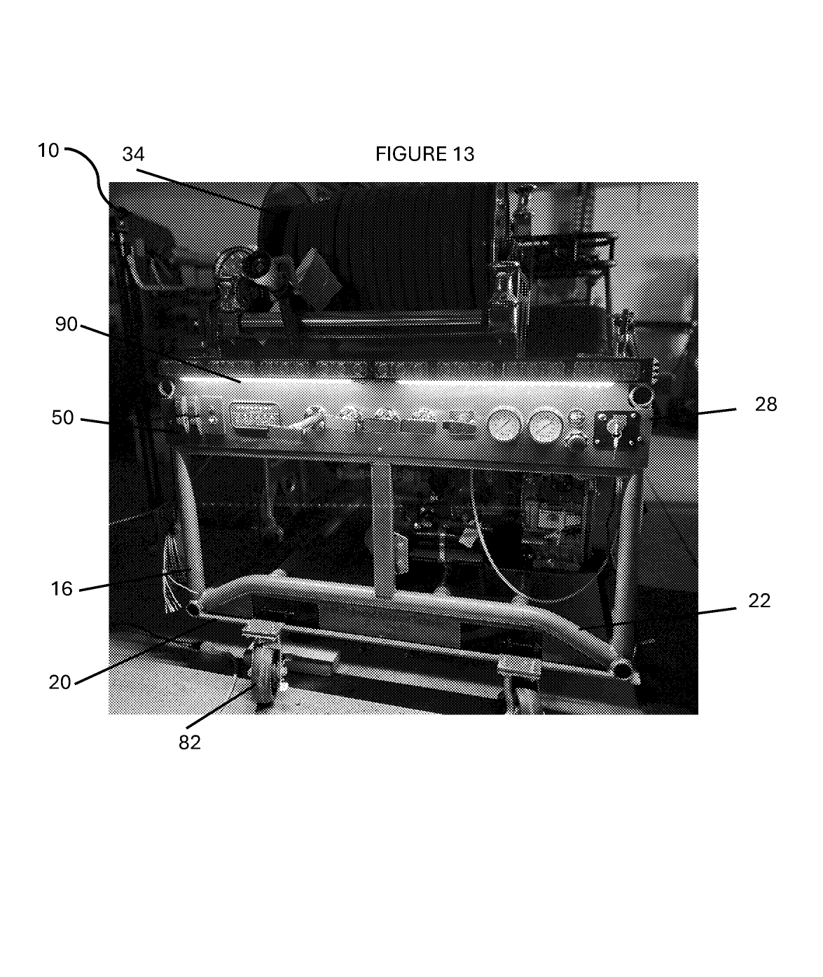

As shown in FIG. 12, the control panel 50 is easily accessible when the interchangeable equipment sled 10 is within a truck bed 15 when a tailgate 84 is up and the control panel 50 rests above the tailgate 84. In prior art equipment sleds, the tailgate is required to be removed in the vehicle to insert the sled and the sled must be fixed within the vehicle. In the present invention, the tailgate 84 can stay intact and the interchangeable equipment sled 10 can be removed easily from the vehicle 14. There are many essential systems within the tailgate 84 and if it is removed, functionality of the vehicle 14 is removed. Once the interchangeable equipment sled 10 is removed from the vehicle 14, the vehicle 14 can function as normal including the tailgate 84. A traffic director 86 can be operatively attached on top of the control panel 50 for controlling traffic around the vehicle 14. The control panel 50 can be illuminated with lights 90 as shown in FIG. 13 and the lights can be integrated in any suitable place along the control panel 50. The control panel 50 can be connected to a vehicle power source through a trailer coupling (pigtail) or it can run on battery power.

The frame 16 can further include a plurality of wheels 82 removably attached along the base portion 20, shown in FIGS. 11 and 13. The wheels allow the interchangeable equipment sled 10 to be easily pushed and moved by an individual or group of individuals when on a level surface such as in a garage or road. Alternatively the interchangeable equipment sled 10 can be placed on a wheeled cart for movement. A tractor can also easily move the interchangeable equipment sled 10 if outdoors on land, such as if it is dropped off at a farm.

The equipment 12 can be operated or turned on/off manually or with an application on a smartphone with BLUETOOTH® or wireless communication.

The vehicle 14 can be a car, pickup truck, flat bed truck, semi truck, trailer, or any other vehicle. The interchangeable equipment sled 10 can be sized to fit on any existing vehicle 14 or be manufactured to be included on new vehicles 14. Multiple vehicles 14 can be used, such as a pickup truck and a trailer, to carry multiple interchangeable equipment sleds 10.

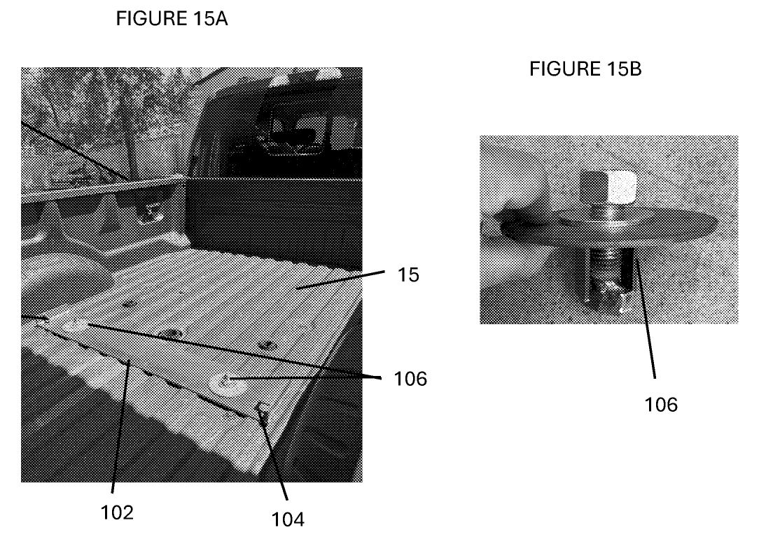

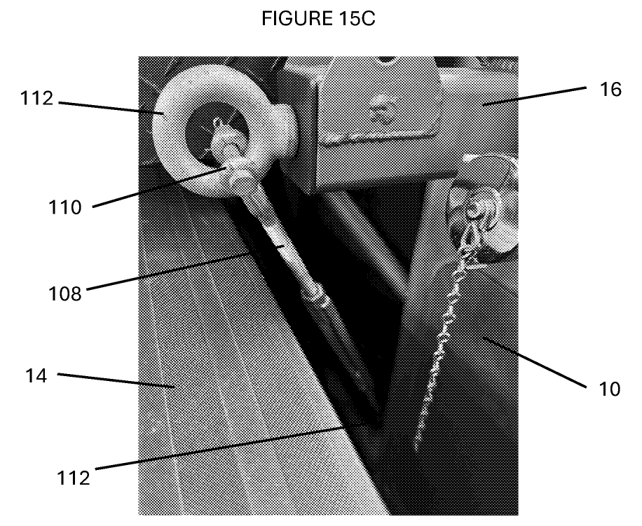

The interchangeable equipment sled 10 can further include any suitable locking/attachment mechanism to lock the interchangeable equipment sled 10 in place on the vehicle 14. However, a locking mechanism is not necessary as the interchangeable equipment sled 10 can be heavy enough to stay in place within the vehicle 14. The interchangeable equipment sled 10 can further include any suitable locking or attachment mechanism 100 to lock the interchangeable equipment sled 10 in place on the vehicle 14. However, a locking or attachment mechanism 100 is not necessary as the interchangeable equipment sled 10 can be heavy enough to stay in place within the vehicle 14. FIGS. 15A-15C show an example of a locking or attachment mechanism 100 that includes a tie down plate 102 having a plurality of tie down points 104 (preferably two at opposite sides of the vehicle 14). The tie down plate 102 mounts to a gooseneck puck system 106 of a truck bed 15. The tie down plate 102 can have 90 degree bends on either side preventing any side to side motion of the interchangeable equipment sled 10. FIG. 15C shows the interchangeable equipment sled 10 within the vehicle 14, and the frame 16 can be secured to the locking or attachment mechanism 100 through at least one rod 108 that is removably attached at a first end 110 to an attachment point 112 of the frame 16 and removably attached at a second end 114 to the tie down point 104. The attachment point 112 can be any suitable place on the frame 16 that lines up with the gooseneck puck system 106. The attachment point 112 can slide into a 2” receiver tube 116 on the frame 16. Therefore, in the methods described above, locking the interchangeable equipment sled 10 can include securing the rod 108 at the first end 110 to the attachment point 112 on the frame 16 and securing the rod 108 at the second end 114 to the tie down point 104 on the vehicle 14 as described above. The interchangeable equipment sled 10 can include any of the equipment 12 as described above.

The interchangeable equipment sled 10 can easily be added or removed from a vehicle 14 without a crane or forklift with the jack device 200 that can be placed within the jack receiving slot 98 operatively integrated in the frame 16 to lift the interchangeable equipment sled 10 off of the vehicle 14 (such as off of a truck bed 15) a couple of inches, and the vehicle 14 can be driven away with the interchangeable equipment sled 10 staying in place on the jack device 200. The jack receiving slot 98 can preferably be located at the top portion 28 of the frame 16 and a plurality of jack receiving slots 98 can be located along the top portion 28 on the first side 44 and second side 46. The interchangeable equipment sled 10 can also be lowered to ground level with jack devices 200 inserted into multiple receiving slots 98. The jack devices 200 can be used to move the interchangeable equipment sled 10 onto a platform, a rack, onto a floor, or any other storage area. The jack device 200 allows the interchangeable equipment sled 10 to be removed or attached to a vehicle 14 within 10 minutes. The jack device 200 can be operated manually or by the application with BLUETOOTH® or wireless communication. Once on the platform, the platform can be moved with pneumatic wheels for storage either manually or with the application.

The sled 12 can be electrically powered from a battery mounted to sled 12 and/or powered by connecting to a seven blade or similar trailer plug installed on vehicle 14. Charging equipment (solar or corded) can be installed on sled 12 as well.

The present invention provides generally for a method using the interchangeable equipment sled 10, by driving a vehicle 14 including the interchangeable equipment sled 10, and using the equipment 12.

The present invention also provides for a method of using the interchangeable equipment sled 10 to fight a fire, by driving a vehicle 14 including the interchangeable equipment sled 10 with fire equipment 12 to a fire scene, and using the fire equipment 12 to fight the fire. This method is useful in fighting fires in areas where large fire trucks cannot access.

The present invention provides for a method of using the interchangeable equipment sled 10 to charge a vehicle’s 14 battery, by driving a vehicle 14 including the interchangeable equipment sled 10 with battery equipment 12, wherein the battery equipment 12 is operatively connected to the vehicle 14, and charging the vehicle 14 with the battery equipment 12. The method can further include the step of activating or stopping charging with the battery equipment 12 with an application on a smartphone.

The present invention provides for a method of using the interchangeable equipment sled 10 to add fuel to a vehicle’s 14 fuel tank, by driving a vehicle 14 including the interchangeable equipment sled 10 with fueling equipment 12, wherein the fueling equipment 12 is operatively connected to a fuel tank of the vehicle 14, and adding fuel to the vehicle 14 with the fueling equipment 12. The method can further include the step of activating or stopping adding fuel with the fueling equipment 12 with an application on a smartphone.

The interchangeable equipment sled 10 can be used on its own. For example, an individual can buy an interchangeable equipment sled 10 to keep on their property if they live far from a fire station so that they can use the equipment 12 themselves if needed.

The interchangeable equipment sled 10 provides several advantages. For example, volunteer firefighters can add the interchangeable equipment sled 10 to their own vehicle 14 when needed instead of having to go to a fire station to get equipment. The interchangeable equipment sled 10 allows fire stations to buy several sleds 10 for one or two vehicles 14, instead of having to buy multiple specialty vehicles that sit around unused most of the time. The interchangeable equipment sled 10 can be used with smaller vehicles 14 allowing them to move and access places that large fire trucks cannot. The amount of firefighting equipment available can be increased because separate trucks are not required for each piece of equipment.

Throughout this application, various publications, including United States patents, are referenced by author and year and patents by number. Full citations for the publications are listed below. The disclosures of these publications and patents in their entireties are hereby incorporated by reference into this application in order to more fully describe the state of the art to which this invention pertains.

The invention has been described in an illustrative manner, and it is to be understood that the terminology which has been used is intended to be in the nature of words of description rather than of limitation.

Obviously, many modifications and variations of the present invention are possible in light of the above teachings. It is, therefore, to be understood that within the scope of the appended claims, the invention can be practiced otherwise than as specifically described.

What is claimed is:

1. A jack device for lifting a heavy object, comprising:
a first arm having a base at a distal end and a second arm attached substantially perpendicular to the first arm at a proximal end, the second arm including an extendable portion actuated by an eye ring, the first arm including a power and electronics module capable of moving the proximal end relative to the distal end.

2. The jack device of claim 1, wherein said first arm is adjustable from 35 inches fully retracted to 48 inches fully extended.

3. The jack device of claim 1, wherein said proximal end is integrated within said first arm.

4. The jack device of claim 1, wherein said first arm includes an existing jack fitted at its proximal end with a jack extension, and wherein said second arm is attached to said jack extension at a proximal end.

5. The jack device of claim 4, wherein said second arm is attached to said jack extension through a slot.

6. The jack device of claim 1, wherein said second arm is attached to said first arm through a slot.

7. The jack device of claim 1, wherein said base includes gripping materials.

8. The jack device of claim 1, wherein said eye ring runs through a center of said second arm from a first end through at least a portion of said extendable portion.

9. The jack device of claim 1, wherein rotation of said eye ring in a first direction extends the extendable portion, and rotation of said eye ring in a second direction retracts said extendable portion.

10. The jack device of claim 1, wherein said power and electronics module includes a battery and a switch chosen from a manual switch and a remote switch.

11. A method of using a jack device to lift or lower a heavy object, including the steps of:
placing at least one jack device near an object to be lifted or lowered, the jack device including a first arm and a second arm attached substantially perpendicular to the first arm at a proximal end;
extending an extendable portion of the second arm into or under the object to engage with the object; and
actuating vertical movement of the first arm, thereby lifting or lowering the object.

12. The method of claim 11, wherein said extending step is further defined as rotating an eye ring of the second arm in a first direction to extend the extendable portion into or under the object.

13. The method of claim 11, wherein said actuating step is further defined as operating a switch on the jack device by a method chosen from the group consisting of manually and remotely.

14. The method of claim 11, further including the step of removing the jack device from the object by rotating an eye ring of the second arm in a second direction and retracting the extendable portion of the second arm.

15. A method of adding an interchangeable equipment sled to a vehicle, including the steps of:
operating a jack device to lift the interchangeable equipment sled; and
placing the interchangeable equipment sled on the vehicle.

16. The method of claim 15, further including the step of locking the interchangeable equipment sled in place.

17. The method of claim 15, wherein said operating step is further defined as placing a plurality of jack devices near each jack receiving slot of the interchangeable equipment sled, and extending extendable portions of the jack devices into the jack receiving slots by rotating the eye rings in a first direction.

18. The method of claim 15, further including the step of creating a friction-based anchor with the extendable portions to secure the interchangeable equipment sled.

19. The method of claim 15, wherein said operating step further includes actuating vertical movement of the jack devices.

20. The method of claim 19, further including before said placing step, the step of moving a vehicle under the interchangeable equipment sled.

21. The method of claim 19, wherein said placing step is further defined as actuating vertical movement of the jack devices to lower the interchangeable equipment sled onto the vehicle.

22. The method of claim 15, further including the step of removing the jack devices by rotating the eye ring in the second direction to retract the extendable portion of the second arm from the jack receiving slots.

23. A method of removing an interchangeable equipment sled from a vehicle, including the steps of:
operating a jack device to lift the interchangeable equipment sled from the vehicle; and
moving the vehicle away.

24. The method of claim 23, further including before said operating step, the step of unlocking the interchangeable equipment sled.

25. The method of claim 23, wherein said operating step is further defined as placing a plurality of jack devices near each jack receiving slot of the interchangeable equipment sled, and extending extendable portions of the jack devices into the jack receiving slots by rotating the eye rings in a first direction.

26. The method of claim 25, further including the step of creating a friction-based anchor with the extendable portions to secure the interchangeable equipment sled.

27. The method of claim 23, wherein said operating step further includes actuating vertical movement of the jack devices.

28. The method of claim 27, wherein said placing step is further defined as actuating vertical movement of the jack devices to raise the interchangeable equipment sled from the vehicle.
